(19) United States
(12) Patent Application Publication
(10) Pub. No.: US 2017/0132653 A1
(43) Pub. Date: May 11, 2017

(54) METHOD AND SYSTEM FOR ACCUMULATING AND REDEEMING REWARDS USING DIGITAL WALLETS

(71) Applicant: MasterCard Asia/Pacific Pte. Ltd., Singapore (SG)

(72) Inventors: Vijin Venugopalan, Singapore (SG); Joseph Hayes, Montclair, NJ (US); Prashant Sharma, Madison, NJ (US)

(21) Appl. No.: 15/298,658

(22) Filed: Oct. 20, 2016

(30) Foreign Application Priority Data
Nov. 5, 2015 (SG) 10201509121Q

(51) Int. Cl. G06Q 30/02; G06Q 20/34; G06Q 20/36

(52) U.S. Cl. CPC G06Q 30/0238; G06Q 20/36; G06Q 20/34

(57) ABSTRACT

A computer-implemented method for accumulating rewards for redemption is disclosed. The method comprises the steps of storing at a server a first digital wallet, where the first digital wallet is associated with a first standard rewards value, and storing at least one payment card number for a payment card issued by a first issuer where the first issuer has a first issuer server; receiving at the server a rewards value from the first issuer server; applying with the server a normalizing algorithm to the rewards value from the first issuer server to obtain a first normalized rewards value; and updating with the server the first standard rewards value by adding the first normalized rewards value to the first standard rewards value.

### CROSS-REFERENCE TO RELATED APPLICATION

This application is a U.S. National Stage filing under 35 U.S.C. §119, based on and claiming benefit of and priority to SG Patent Application No. 10201509121Q filed Nov. 5, 2015.

### TECHNICAL FIELD

The following discloses a method and system for accumulating and redeeming rewards using digital wallets.

### BACKGROUND

A digital wallet is a software component that allows a customer to make an electronic payment with a financial instrument such as a credit card or a bank account. A server-side digital wallet is one that the digital wallet service provider creates and maintains for a customer on its servers. These types of digital wallets are gaining popularity among customers due to the security and convenience they provide. As all the required information such as shipping address, billing address, payment methods (including credit card numbers, expiry dates, and security numbers) are already stored in the organization's server, the customer is relieved of the mundane and sometimes arduous task of keying in this information when making payment, thereby enhancing the overall purchasing experience.

It is commonplace for credit cards to have rewards and redemption schemes. These schemes are in place to incentivize customers to use the credit cards to make payment, and in return be awarded rewards points that can be redeemed for a monetary value. A digital wallet is usually associated with multiple credit cards or other electronic payment instruments such as debit cards, prepaid cards and store loyalty cards. Usually, the payment cards in a digital wallet are issued by a single issuer such as a bank (e.g. Citibank) or a financial services company (e.g. American Express Company). Therefore, to take advantage of the various incentives across different banks, financial services companies and merchants, a customer would normally have multiple digital wallets, each digital wallet being associated with payment cards issued by a single issuer.

However, the drawback is that as the rewards points system for each payment card in a digital wallet is bank-specific or even payment card-specific, customers are unable to utilize the rewards points issued by a particular bank, for a purchase with a payment card issued by another bank. The result is that a customer ends up with rewards points across many credit cards, but is unable to consolidate the disparate rewards points for redemption in a coherent manner.

Thus, there is a want for a method and system which standardizes and aggregates disparate rewards points accumulated for various digital wallets into a single rewards points system. The points in this single rewards points system can be redeemed with a purchase with any one of the customer's digital wallets and with any participating merchant. Furthermore, other desirable features and characteristics will become apparent from the subsequent detailed description and the appended claims, taken in conjunction with the accompanying drawings and this background of the disclosure.

### SUMMARY

According to a first aspect of the invention, a computer-implemented method for accumulating rewards for redemption is described, the method comprising the steps of storing at a server, a first digital wallet, the first digital wallet associated with a first standard rewards value and storing at least one payment card number for a payment card issued by a first issuer, the first issuer having a first issuer server; receiving at the server, a rewards value from the first issuer server; applying with the server, a normalizing algorithm to the rewards value from the first issuer server to obtain a first normalized rewards value; and updating with the server, the first standard rewards value by adding the first normalized rewards value to the first standard rewards value.

Preferably, the computer-implemented method further comprises the steps of receiving at the server, instructions that payment is to be made with the first digital wallet; sending from the sever, the first standard rewards value to a customer device for display; receiving at the server, instructions from the customer device that a portion or an entirety of the first standard rewards value has been selected; and providing from the server, the selected portion or the selected entirety of the first standard rewards value to a merchant server for redemption.

Preferably, the computer-implemented method further comprises the steps of storing at the server, a second digital wallet, the second digital wallet associated with a second standard rewards value and storing at least one payment card number for a payment card issued by a second issuer, the second issuer having a second issuer server; receiving at the server, a rewards value from the second issuer server; applying with the server, the normalizing algorithm to the rewards value from the second issuer server to obtain a second normalized rewards value; updating with the server, the second standard rewards value by adding the second normalized rewards value to the second standard rewards value; and adding with the server, the first standard rewards value and the second standard rewards value to obtain a consolidated standard rewards value.

Preferably, the computer implemented method further comprises the steps of sending from the server, the consolidated standard rewards value to the customer device for display; receiving at the server, instructions from the customer device that a portion or an entirety of the consolidated standard rewards value has been selected; and providing from the server, the selected portion or the selected entirety of the consolidated standard rewards value to the merchant server for redemption.

Preferably, the step of applying the normalizing algorithm comprises scaling the rewards value from the first issuer server or the rewards value from the second issuer server by a predetermined factor, wherein the predetermined factor is correlated to a ratio between the dollar value of the rewards value from the first issuer server and the dollar value of the rewards value from the second issuer server.

Preferably, the step of receiving the rewards value from the first issuer server is via an application programming interface (API).

Preferably, the step of receiving the rewards value from the second issuer server is via another API.

Preferably, the first standard rewards value is stored in the first digital wallet and the second standard rewards value is stored in the second digital wallet.

Preferably, the merchant server is associated with a merchant category code such that the selected portion or the selected entirety of the first standard rewards value or the selected portion or the selected entirety of the consolidated standard rewards value can be redeemed.

According to a second aspect of the invention, a system for accumulating rewards for redemption is described, the system for accumulating rewards for redemption comprising at least one server configured to store a first digital wallet, the first digital wallet associated with a first standard rewards value, and storing at least one payment card number for a payment card issued by a first issuer, the first issuer having a first issuer server; receive a rewards value from the first issuer server; apply a normalizing algorithm to the rewards value from the first issuer server to obtain a first normalized rewards value; and update the first standard rewards value by adding the first normalized rewards value to the first standard rewards value.

Preferably, the at least one server is further configured to receive instructions that payment is to be made with the first digital wallet; send the first standard rewards value to a customer device for display; receive instructions from the customer device that a portion or an entirety of the first standard rewards value has been selected; and provide the selected portion or the selected entirety of the first standard rewards value to a merchant server for redemption.

Preferably, the at least one server is further configured to store a second digital wallet, the second digital wallet associated with a second standard rewards value, and storing at least one payment card number for a payment card issued by a second issuer, the second issuer having a second issuer server; receive a rewards value from the second issuer server; apply the normalizing algorithm to the rewards value from the second issuer server to obtain a second normalized rewards value; update the second standard rewards value by adding the second normalized rewards value to the second standard rewards value; and add the first standard rewards value and the second standard rewards value to obtain a consolidated standard rewards value.

Preferably, the at least one server is further configured to send the consolidated standard rewards value to the customer device for display; receive instructions from the customer device that a portion or an entirety of the consolidated standard rewards value has been selected; and provide the selected portion or the selected entirety of the consolidated standard rewards value to the merchant server for redemption.

Preferably, the normalizing algorithm comprises scaling the rewards value from the first issuer server or the rewards value from the second issuer server by a predetermined factor, wherein the predetermined factor is correlated to a ratio between the dollar value of the rewards value from the first issuer server and the dollar value of the rewards value from the second issuer server.

Preferably, the at least one server is further configured to receive the rewards value from the first issuer server via an application programming interface (API).

Preferably, the at least one server is further configured to receive the rewards value from the second issuer server via another API.

Preferably, the first standard rewards value is stored in the first digital wallet and the second standard rewards value is stored in the second digital wallet.

Preferably, the merchant server is associated with a merchant category code such that the selected portion or the selected entirety of the first standard rewards value or the selected portion or the selected entirety of the consolidated standard rewards value can be redeemed.

According to a third aspect of the invention, a computer program product for accumulating rewards for redemption is described, the computer program product embodied on a non-transitory computer readable storage medium comprising executable computer readable program code configured to, when executed on at least one processor, cause an apparatus or system to store a first digital wallet, the first digital wallet associated with a first standard rewards value, and storing at least one payment card number for a payment card issued by a first issuer, the first issuer having a first issuer server; receive a rewards value from the first issuer server; apply a normalizing algorithm to the rewards value from the first issuer server to obtain a first normalized rewards value; and update the first standard rewards value by adding the first normalized rewards value to the first standard rewards value.

Preferably, the computer readable program code is further configured to, when executed on at least one processor, cause an apparatus or system to receive instructions that payment is to be made with the first digital wallet; send the first standard rewards value to a customer device for display; receive instructions from the customer device that a portion or an entirety of the first standard rewards value has been selected; and provide the selected portion or the selected entirety of the first standard rewards value to a merchant server for redemption.

Preferably, the computer readable program code is further configured to, when executed on at least one processor, cause an apparatus or system to store a second digital wallet, the second digital wallet associated with a second standard rewards value, and storing at least one payment card number for a payment card issued by a second issuer, the second issuer having a second issuer server; receive a rewards value from the second issuer server; apply the normalizing algorithm to the rewards value from the second issuer server to obtain a second normalized rewards value; update the second standard rewards value by adding the second normalized rewards value to the second standard rewards value; and add the first standard rewards value and the second standard rewards value to obtain a consolidated standard rewards value.

Preferably, the computer readable program code is further configured to, when executed on at least one processor, cause an apparatus or system to send the consolidated standard rewards value to the customer device for display; receive instructions from the customer device that a portion or an entirety of the consolidated standard rewards value has been selected; and provide the selected portion or the selected entirety of the consolidated standard rewards value to the merchant server for redemption.

Preferably, the computer readable program code is further configured to, when executed on at least one processor, cause an apparatus or system to apply the normalizing algorithm by scaling the rewards value from the first issuer server or the rewards value from the second issuer server by a predetermined factor, wherein the predetermined factor is correlated to a ratio between the dollar value of the rewards value from the first issuer server and the dollar value of the rewards value from the second issuer server.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to illustrate various embodiments, by way of example only, and to explain various principles and advantages in accordance with a present embodiment.

FIG. 1 is a block diagram depicting a system in which a customer can accumulate rewards points.

FIG. 2 shows an exemplary service provider server for performing the functions in accordance with an embodiment of the invention.

FIG. 3 shows an exemplary customer device for performing the functions as described herein.

FIG. 4 is a flow chart depicting a method for accumulating rewards points with a digital wallet.

FIG. 5 is a flow chart depicting a method for accumulating rewards points with another digital wallet.

FIG. 6 is a block diagram depicting a system in which a customer redeems rewards points.

FIG. 7 is a flow chart depicting a method for redeeming rewards points with a digital wallet.

Skilled artisans will appreciate that elements in the figures are illustrated for simplicity and clarity and have not necessarily been depicted to scale. For example, the dimensions of some of the elements in the block diagrams or steps in the flowcharts may be exaggerated with respect to other elements to help improve understanding of the present embodiment.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description. It is the intent of the preferred embodiments to disclose a method and system for standardizing and consolidating disparate rewards points accumulated for various financial instruments into a single rewards points system.

Currently, there exists no mechanism that allows customers to standardize and consolidate their rewards points accumulated for their various financial instruments. This results in customers being unable to utilize their rewards points freely.

Certain embodiments of the present invention seek to address the above challenges by disclosing a method and system that standardizes and aggregates disparate rewards points accumulated for various digital wallets into a single rewards points system. The points in this single rewards points system can be redeemed with a purchase from any of the customer's digital wallets and with any participating merchant. This is also known as an “open-loop points standard” in which the standardized points can be used across various issuers and merchants.

Certain embodiments of the present invention also seek to provide a secure ecosystem for rewards points to be passed from the issuer to the customer, and then onto the merchant for redemption. This is achieved by a server being placed intermediate between the issuers and merchants, the server implementing an open Application Programming Interface (API) based secure communication channel.

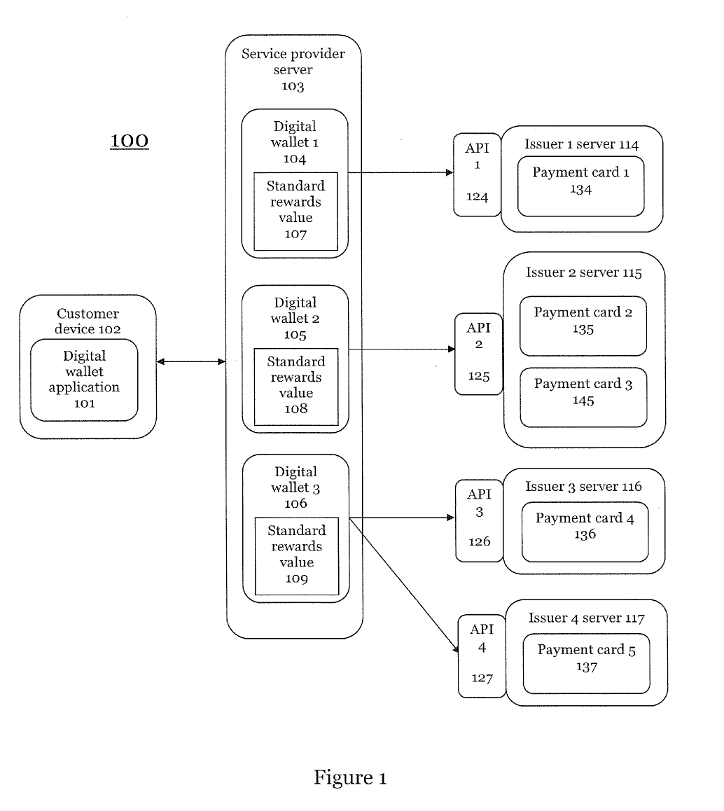

FIG. 1 is a block diagram depicting a system 100 in which a customer can accumulate rewards points. System 100 comprises digital wallet application 101 installed on customer device 102. Customer device 102 may be any electronic device, non-exhaustively including, a smart phone, a handheld, a tablet, a laptop computer or a desktop computer or the like. System 100 further comprises service provider server 103, which hosts and stores digital wallet 1 104, digital wallet 2 105 and digital wallet 3 106. Digital wallet 1 104, digital wallet 2 105 and digital wallet 3 106 belong to the same customer. The customer can use digital wallet application 101 on customer device 102 to access any one of his three digital wallets. This is because customer device 102 is communicable with service provider server 103 in that customer device 102 can send data to, and receive data from service provider server 103. Although it is shown in this instance that the customer has three digital wallets, this is for illustration purposes only and there is no restriction on the number of digital wallets a customer can have.

Also in system 100 is issuer 1 server 114, issuer 2 server 115, issuer 3 server 116 and issuer 4 server 117. Issuer 1 server 114 provides payment card 1 134 to the customer. Issuer 2 server 115 provides payment card 2 135 and payment card 3 145 to the customer. Issuer 3 server 116 provides payment card 4 136 to the customer. Issuer 4 server 117 provides payment card 5 137 to the customer. Issuer 1 server 114 is managed by issuer 1, issuer 2 server 115 is managed by issuer 2, issuer 3 server 116 is managed by issuer 3 and issuer 4 server 117 is managed by issuer 4. Issuer 1, issuer 2, issuer 3 and issuer 4 can be any bank or financial services company. Service provider server 103 communicates with issuer 1 server 114 via an application programming interface (API) 1 124. Service provider server 103 communicates with issuer 2 server 115 via an application programming interface (API) 2 125. Service provider server 103 communicates with issuer 3 server 116 via an application programming interface (API) 3 126. Service provider server 103 communicates with issuer 4 server 117 via an application programming interface (API) 4 127.

Digital wallet 1 104 is associated with payment card 1 134, which may be a credit card, debit card or prepaid card, for example. In other words, payment card 1 134 is provisioned onto digital wallet 1 104. Payment card 1 134 is issued by issuer 1. Digital wallet 1 104 can store the card number (e.g. the primary account number or PAN) of payment card 1 134. Digital wallet 2 105 is associated with payment card 2 135 and payment card 3 145. In other words, payment card 2 135 and payment card 3 145 are provisioned onto digital wallet 2 105. Payment card 2 135 and payment card 3 145 are issued by issuer 2. Digital wallet 2 105 can store the card number of payment card 2 135 and the card number of payment card 3 145. Digital wallet 3 106 is associated with payment card 4 136 and payment card 5 137. In other words, payment card 4 136 and payment card 5 137 are provisioned onto digital wallet 3 106. Payment card 4 136 is issued by issuer 3 while payment card 5 137 is issued by issuer 4. Despite the fact that payment card 4 136 and payment card 5 137 are issued by different issuers, payment card 4 136 and payment card 5 137 can still be provisioned on the same digital wallet i.e. digital wallet 3 106. This is because digital wallet 3 106 can be an open wallet. Digital wallet 3 106 can store the card number of payment card 4 136 and the card number of payment card 5 137. Although it is shown in this instance that a digital wallet is associated with one or two payment cards, this is for illustration purposes only and there no restriction on the number of payment cards a digital wallet can be associated with.

Digital wallet 1 104 is associated with standard rewards value 107. Preferably, standard rewards value 107 is stored in digital wallet 1 104. Alternatively, standard rewards value 107 can be stored in a customer account in service provider server 103 which digital wallet 1 104 has access to. Digital wallet 2 105 is associated with standard rewards value 108. Preferably, standard rewards value 108 is stored in digital wallet 2 105. Alternatively, standard rewards value 108 can be stored in a customer account in service provider server 103 in which digital wallet 2 105 has access to. Digital wallet 3 106 is associated with standard rewards value 109. Preferably, standard rewards value 109 is stored in digital wallet 3 106. Alternatively, standard rewards value 109 can be stored in a customer account in service provider server 103 in which digital wallet 3 106 has access to. Service provider server 103 can read, and write to update standard rewards value 107, standard rewards value 108 and standard rewards value 109. Standard rewards value 107, standard rewards value 108 and standard rewards value 109 can be a whole number.

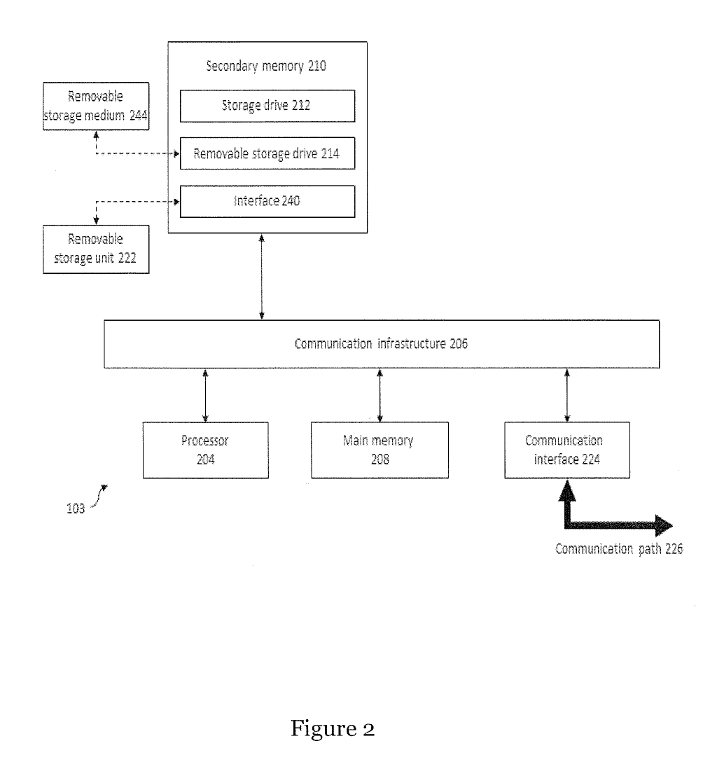

The following description of service provider server 103 is provided by way of example only and is not intended to be limiting. Service provider server 103 may be a server or comprise a plurality of servers. As shown in FIG. 2, the exemplary service provider server 103 includes a processor 204 for executing software routines. Although a single processor is shown for the sake of clarity, service provider server 103 may also include a multi-processor system. The processor 204 is connected to a communication infrastructure 206 for communication with other components of service provider server 103. The communication infrastructure 206 may include, for example, a communications bus, cross-bar, or network. Service provider server 103 further includes a main memory 208, such as a random access memory (RAM), and a secondary memory 210.

The secondary memory 210 may include, for example, a storage drive 212, which may be a hard disk drive, a solid state drive or a hybrid drive and/or a removable storage drive 214, which may include a magnetic tape drive, an optical disk drive, a solid state storage drive (such as a USB flash drive, a flash memory device, a solid state drive or a memory card), or the like. The removable storage drive 214 reads from and/or writes to a removable storage medium 244 in a well-known manner. The removable storage medium 244 may include magnetic tape, optical disk, non-volatile memory storage medium, or the like, which is read by and written to by removable storage drive 214. As will be appreciated by persons skilled in the relevant art(s), the removable storage medium 244 includes a computer readable storage medium having stored therein computer executable program code instructions and/or data. In an alternative implementation, the secondary memory 210 may additionally or alternatively include other similar means for allowing computer programs or other instructions to be loaded into service provider server 103. Such means can include, for example, a removable storage unit 222. Examples of a removable storage unit 222 include a program cartridge and cartridge interface (such as that found in video game console devices), a removable memory chip (such as an EPROM or PROM) and associated socket, a removable solid state storage drive (such as a USB flash drive, a flash memory device, a solid state drive or a memory card), and other removable storage units 222 which allow software and data to be transferred from the removable storage unit 222 to service provider server 103.

Service provider server 103 also includes at least one communication interface 224. The communication interface 224 allows software and data to be transferred between service provider server 103 and external devices via a communication path 226. For example, data can be transferred between service provider server 103 and customer device 102 via communication interface 224. In various embodiments of the inventions, the communication interface 224 permits data to be transferred between service provider server 103 and a data communication network, such as a public data or private data communication network. Examples of a communication interface 224 can include a modem, a network interface (such as an Ethernet card), a communication port (such as a serial, parallel, printer, GPIB, IEEE 1394, RJ45, USB), an antenna with associated circuitry and the like. The communication interface 224 may be wired or may be wireless. Software and data transferred via the communication interface 224 are in the form of signals which can be electronic, electromagnetic, optical or other signals capable of being received by communication interface 224. These signals are provided to the communication interface via the communication path 226.

Software may be stored in a computer program product and loaded into service provider server 103 using the removable storage drive 214, the storage drive 212, or the interface 240. Alternatively, the computer program product may be downloaded to service provider server 103 over the communications path 226. The software, when executed by the processor 204, causes service provider server 103 to perform functions of embodiments described herein. It is to be understood that the embodiment of FIG. 2 is presented merely by way of example. Therefore, in some embodiments one or more features of service provider server 103 may be omitted. Also, in some embodiments, one or more features of service provider server 103 may be combined together. Additionally, in some embodiments, one or more features of service provider server 103 may be split into one or more component parts.

As used herein, the term “computer program product” may refer, in part, to removable storage medium 244, removable storage unit 222, a hard disk installed in storage drive 212, or a carrier wave carrying software over communication path 226 (wireless link or cable) to communication interface 224. Computer readable storage media or medium refers to any non-transitory, non-volatile tangible storage medium that provides recorded instructions and/or data to service provider server 103 for execution and/or processing. Examples of such storage media include magnetic tape, CD-ROM, DVD, Blu-ray™ Disc, a hard disk drive, a ROM or integrated circuit, a solid state storage drive (such as a USB flash drive, a flash memory device, a solid state drive or a memory card), a hybrid drive, a magneto-optical disk, or a computer readable card such as a PCMCIA card and the like, whether or not such devices are internal or external of service provider server 103. Examples of transitory or non-tangible computer readable transmission media that may also participate in the provision of software, application programs, instructions and/or data to service provider server 103 include radio or infra-red transmission channels as well as a network connection to another computer or networked device, and the Internet or Intranets including e-mail transmissions and information recorded on Websites and the like.

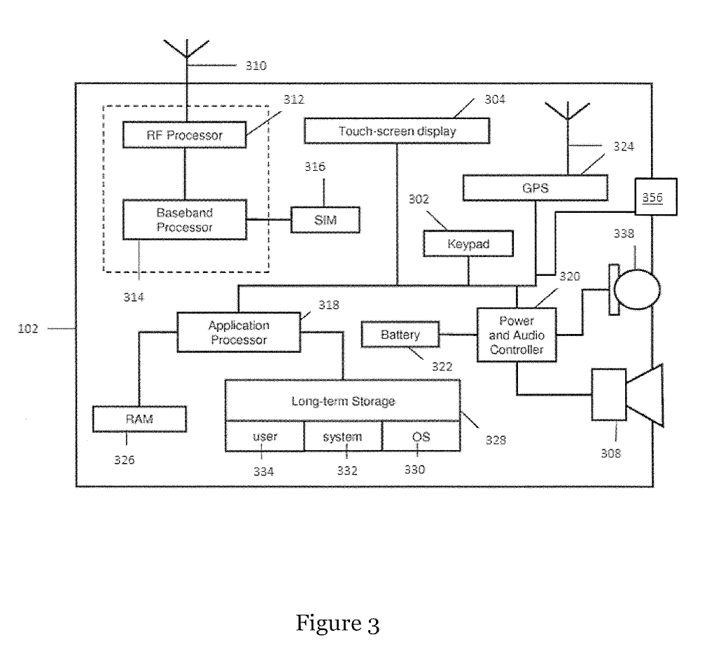

FIG. 3 is a schematic of an exemplary customer device 102. Customer device 102 comprises keypad 302, touch-screen display 304, microphone 338, speaker 308 and antenna 310. Customer device 102 is capable of being operated by a customer to perform a variety of different functions, such as, for example, hosting a telephone call, sending an SMS message, browsing the Internet, sending an email and providing satellite navigation. Customer device 102 comprises hardware to perform communication functions (e.g. telephony, data communication), together with an application processor and corresponding support hardware to enable the wireless device have other functions, such as, messaging, Internet browsing, email functions and the like. The communication hardware is represented by RF processor 312 which provides an RF signal to the antenna 310 for the transmission of data signals, and the receipt therefrom. For example, customer device 102 can send data to, and receive data from service provider server 103 via antenna 310. Additionally provided is baseband processor 314, which provides signals to and receives signals from RF Processor 312. Baseband processor 314 also interacts with a subscriber identity module 316, as is well known in the art. The communication subsystem enables customer device 102 to communicate via a number of different communication protocols including 3G, 4G, GSM, WiFi, Wi-fi direct, Near Field Communication (NFC), Bluetooth™ and/or CDMA.

Keypad 302 and touch-screen display 304 are controlled by application processor 318. Power and audio controller 320 is provided to supply power from battery 322 to the communication subsystem, application processor 318, and the other hardware. Power and audio controller 320 also controls input from microphone 338, and audio output via speaker 308. Also provided is global positioning system (GPS) antenna and associated receiver element 324 which is controlled by application processor 318 and is capable of receiving a GPS signal for use with a satellite navigation functionality of customer device 102.

In order for the application processor 318 to operate, various different types of memory are provided. Firstly, customer device 102 includes Random Access Memory (RAM) 326 connected to application processor 318 into which data and program code can be written and read from at will. Code placed anywhere in RAM 326 can be executed by application processor 318 from RAM 326. RAM 326 represents a volatile memory of customer device 102. Secondly, customer device 102 is provided with long-term storage 328 connected to application processor 318. Long-term storage 328 comprises three partitions, an operating system (OS) partition 330, system partition 332 and user partition 334. Long-term storage 328 represents a non-volatile memory of customer device 102.

In the present example, OS partition 330 contains the firmware of customer device 102 which includes an operating system. Other computer programs may also be stored on long-term storage 328, such as application programs, and the like. In particular, application programs which are mandatory to customer device 102, such as, in the case of a smartphone, communications applications and the like are typically stored in system partition 332. The application programs stored on system partition 332 would typically be those which are bundled with customer device 102 by the device manufacturer when customer device 102 is first sold. Application programs which are added to customer device 102 by the customer would usually be stored in user partition 334. For example, digital wallet application 101 can be stored in user partition 334. As stated, the representation of FIG. 3 is schematic. In practice, the various functional components illustrated may be substituted into one and the same component. For example, long-term storage 328 may comprise NAND flash, NOR flash, a hard disk drive or a combination of these. Customer device 102 may also have an image capturing module 356. Image capturing module 356, together with a suitable application, may be used to capture/scan QR codes and process the data embedded in the QR code.

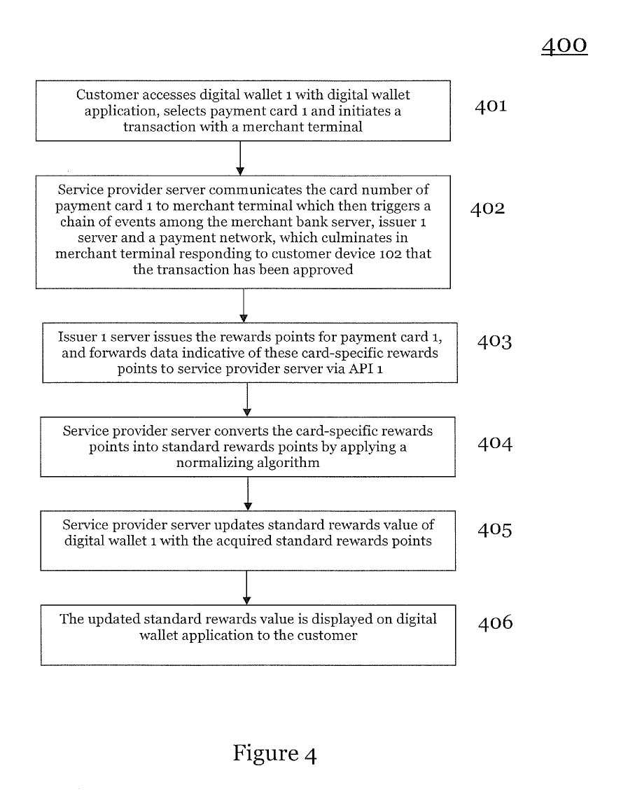

FIG. 4 is a flow chart depicting a method 400 for accumulating rewards points with digital wallet 1 104.

In step 401, the customer accesses digital wallet 1 104 with digital wallet application 101, selects payment card 1 134 and initiates a transaction with a merchant terminal. The transaction could be initiated by the customer tapping customer device 102 against the NFC (Near field communication)-enabled merchant terminal.

In step 402, service provider server 103 communicates the card number of payment card 1 134 to merchant terminal which then triggers a chain of events among the merchant bank server, issuer 1 server 114 and a payment network, which culminates in merchant terminal responding to customer device 102 that the transaction has been approved. The merchant bank server is the server of a bank which processes the merchant-related transactions. An example of the payment network is the MasterCard® payment network.

In step 403, issuer 1 server 114 issues the rewards points for payment card 1 134, and forwards data indicative of these card-specific rewards points to service provider server 103 via API 1 124.

In step 404, service provider server 103 converts the card-specific rewards points into standard rewards points by applying a normalizing algorithm. This step is important as the rewards points for different rewards issuers and merchants have differing weights and values. For example, the rewards points for buying a coffee drink with a payment card from a particular rewards issuer may be in the double digits. On the other hand, the rewards points for buying the same coffee drink with a payment card from another rewards issuer may be in the thousands. Therefore, it is crucial to normalize the disparate rewards points in order to obtain a standardized rewards points system or an “open-loop points standard” so that the standard points can be used across various rewards issuers and merchants.

The normalizing algorithm can involve scaling rewards points by a predetermined factor. This predetermined factor can be correlated to a ratio between the dollar value of the rewards points of the different rewards issuers. For example, if rewards issuer 1 offers 1000 rewards points for a $1 spend while rewards issuer 2 offers 10 rewards points for a $1 spend, then the ratio between the dollar value of the rewards points of rewards issuer 1 and the rewards points of issuer 2 could be 100 is to 1, or 100:1. The predetermined factor would then be 100. In this scenario, the normalizing algorithm would scale the rewards points of rewards issuer 2 by the predetermined factor of 100 so as to normalize the rewards points of issuer 2 with the rewards points of rewards issuer 1. The determination of the ratio between the dollar value of the rewards points of the different rewards issuers is essentially a business decision which requires an agreement between the different rewards issuers.

In step 405, service provider server 103 updates standard rewards value 107 of digital wallet 1 104 with the acquired standard rewards points. This update procedure could be an addition of the acquired standard rewards points to standard rewards value 107.

In step 406, the updated standard rewards value 107 is displayed on digital wallet application 101 to the customer.

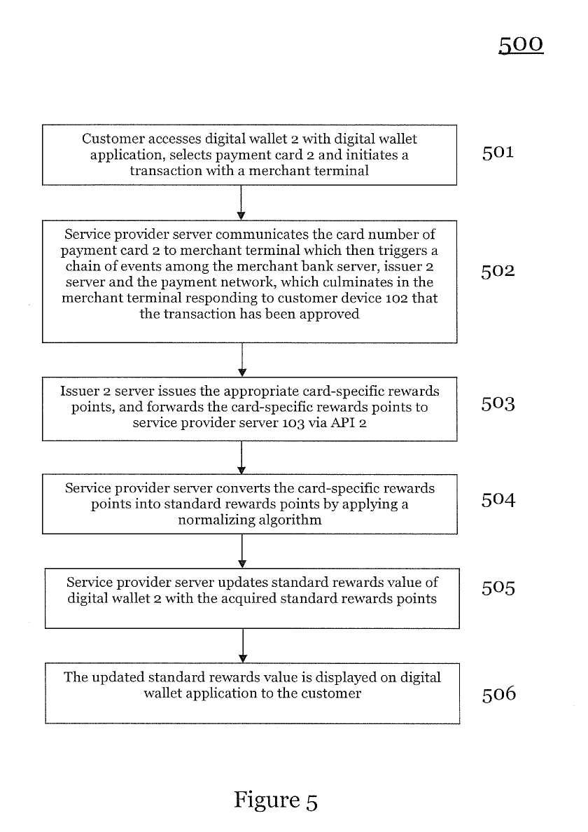

FIG. 5 is a flow chart depicting a method 500 for accumulating rewards points with digital wallet 2 105.

In step 501, the customer accesses digital wallet 2 105 with digital wallet application 101, selects payment card 2 135 and initiates a transaction with a merchant terminal. The transaction could be initiated by the customer tapping customer device 102 against the NFC (Near field communication)-enabled merchant terminal. As digital wallet 2 105 is provisioned with both payment card 2 135 and payment card 3 145, the customer can choose to make payment with payment card 3 145 instead of payment card 2 135.

In step 502, service provider server 103 communicates the card number of payment card 2 135 to merchant terminal which then triggers a chain of events among the merchant bank server, issuer 2 server 115 and the payment network, which culminates in the merchant terminal responding to customer device 102 that the transaction has been approved.

In step 503, issuer 2 server 115 issues the appropriate card-specific rewards points, and forwards the card-specific rewards points to service provider server 103 via API 2 125.

In step 504, service provider server 103 converts the card-specific rewards points into standard rewards points by applying a normalizing algorithm. This step is similar to step 404 as described above.

In step 505, service provider server 103 updates standard rewards value 108 of digital wallet 2 105 with the acquired standard rewards points. This update procedure could be an addition of the acquired standard rewards points to standard rewards value 108.

In step 506, the updated standard rewards value 108 is displayed on digital wallet application 101 to the customer.

The method in which digital wallet 3 106 accumulates rewards points and in which standard rewards value 109 is updated is similar to the above described methods for digital wallet 1 104 and digital wallet 2 105. To avoid being repetitive, the method in which digital wallet 3 106 accumulates rewards points and in which standard rewards value 109 is updated is not explicitly illustrated in this document.

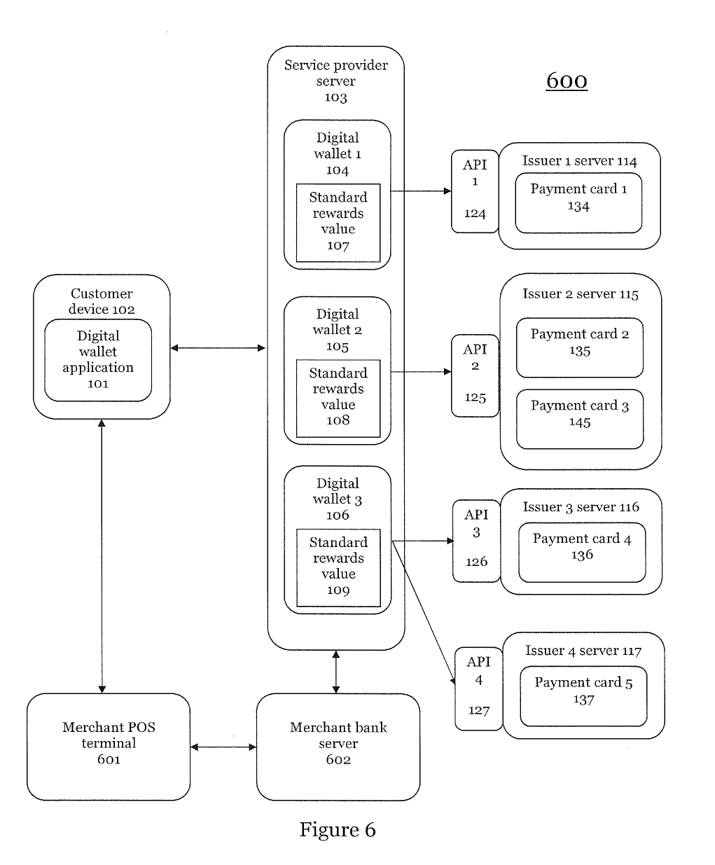

FIG. 6 is a block diagram depicting a system 600 in which a customer redeems rewards points. System 600 comprises digital wallet application 101 installed on customer device 102. Preferably, customer device 102 is NFC (Near Field Communication) enabled. System 600 further comprises service provider server 103, which hosts and stores digital wallet 1 104, digital wallet 2 105 and digital wallet 3 106. System 600 further comprises merchant POS (point of sale) terminal 601 and merchant bank server 602. Merchant bank server 602 is the server of a bank which processes the merchant-related transactions. Preferably, customer device 102 can send instructions to merchant POS terminal 601 via the NFC protocol. Service provider server 103 can send data and instructions to merchant bank server 602. Service provider server 103 can receive data and instructions from merchant bank server 602.

Digital wallet 1 104 is associated with payment card 1 134 i.e. payment card 1 134 is provisioned onto digital wallet 1 104. Digital wallet 2 105 is associated with payment card 2 135 and payment card 3 145 i.e. payment card 2 135 and payment card 3 145 are provisioned onto digital wallet 2 105. Digital wallet 3 106 is associated with payment card 4 136 and payment card 5 137 i.e. payment card 4 136 and payment card 5 137 are provisioned onto digital wallet 3 106. Issuer 1 server 114 provides payment card 1 134 to the customer. Issuer 2 server 115 provides payment card 2 135 and payment card 3 145 to the customer. Issuer 3 server 116 provides payment card 4 136 to the customer. Issuer 4 server 117 provides payment card 5 137 to the customer.

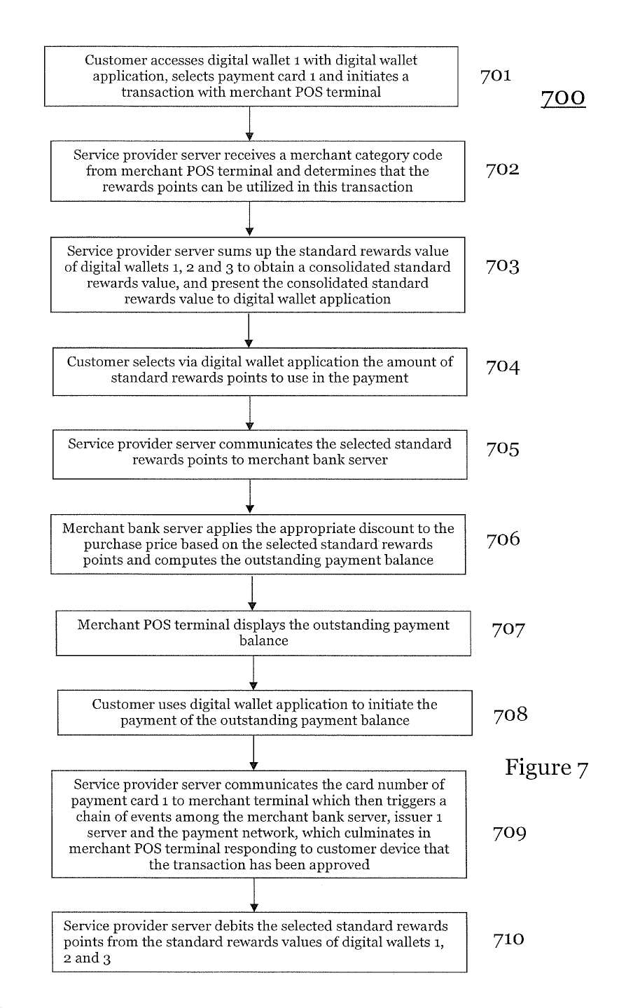

FIG. 7 is a flow chart depicting a method 700 for redeeming rewards points with digital wallet 1 104.

In step 701, the customer accesses digital wallet 1 104 with digital wallet application 101, selects payment card 1 134 and initiates a transaction with merchant POS terminal 601. The transaction could be initiated by the customer tapping customer device 102 against the NFC-enabled merchant POS terminal 601.

In step 702 service provider server 103 receives a merchant category code from merchant POS terminal 601 and determines that the rewards points can be utilized in this transaction.

In step 703, service provider server 103 sums up standard rewards value 107, standard rewards value 108 and standard rewards value 109 to obtain a consolidated standard rewards value, and presents the consolidated standard rewards value to digital wallet application 101. This allows the customer the opportunity to utilize the consolidated rewards points accumulated in digital wallet 1 104, digital wallet 2 105 and digital wallet 3 106 in offsetting partially or fully the purchase price.

In step 704, customer selects via digital wallet application 101 the amount of standard rewards points to use in the payment. The customer may decide to use a portion of the consolidated standard rewards value or all of it.

In step 705, service provider server 103 communicates the selected standard rewards points to merchant bank server 602.

In step 706, merchant bank server 602 applies the appropriate discount to the purchase price based on the selected standard rewards points and computes the outstanding payment balance.

In step 707, merchant POS terminal 601 displays the outstanding payment balance.

In step 708, customer uses digital wallet application 101 to initiate the payment of the outstanding payment balance.

In step 709, service provider server 103 communicates the card number of payment card 1 134 to merchant POS terminal 601 which then triggers a chain of events among the merchant bank server 602, issuer 1 server 114 and a payment network, which culminates in merchant POS terminal 601 responding to customer device 102 that the transaction has been approved. An example of the payment network is the MasterCard® payment network.

In step 710, service provider server 103 debits the selected standard rewards points from standard rewards value 107, standard rewards value 108 and standard rewards value 109.

Therefore, what has been disclosed is a method and system that standardizes and aggregates disparate rewards points accumulated for various digital wallets into a single rewards points system. The points in this single rewards points system can be redeemed with a purchase from any of the customer's digital wallets and with any participating merchant. This allows customers to fully utilize their accumulated rewards points, enhancing the overall customer's experience. This may even incentivize customers to perform even more transactions with their digital wallets, with the knowledge that their accumulated rewards points across their various digital wallets can be consolidated and utilized with any participating merchant. Another benefit is that certain embodiments of the invention discloses a secure ecosystem for rewards points to be passed from the issuer to the customer, and then onto the merchant for redemption. This is achieved by service provider server 103 being placed intermediate between the issuer servers and merchant bank servers, and service provider server 103 implementing an open Application Programming Interface (API) based secure communication channel.

In the application, unless specified otherwise, the terms “comprising”, “comprise”, and grammatical variants thereof, intended to represent “open” or “inclusive” language such that they include recited elements but also permit inclusion of additional, non-explicitly recited elements. The invention illustratively described herein may suitably be practiced in the absence of any element or elements, limitation or limitations, not specifically disclosed herein. Thus, for example, the terms “comprising”, “including”, “containing”, etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the inventions embodied therein herein disclosed may be resorted to by those skilled in the art, and that such modifications and variations are considered to be within the scope of this invention.

1. A computer-implemented method for accumulating rewards for redemption comprising the steps of:
storing at a server, a first digital wallet, the first digital wallet associated with a first standard rewards value and storing at least one payment card number for a payment card issued by a first issuer, the first issuer having a first issuer server;
receiving at the server, a rewards value from the first issuer server;
applying with the server, a normalizing algorithm to the rewards value from the first issuer server to obtain a first normalized rewards value; and
updating with the server, the first standard rewards value by adding the first normalized rewards value to the first standard rewards value.

2. The computer-implemented method of claim 1 further comprising the steps of:
receiving at the server, instructions that payment is to be made with the first digital wallet;
sending from the server, the first standard rewards value to a customer device for display;
receiving at the server, instructions from the customer device that a portion or an entirety of the first standard rewards value has been selected; and
providing from the server, the selected portion or the selected entirety of the first standard rewards value to a merchant server for redemption.

3. The computer-implemented method of claim 1 further comprising the steps of:
storing at the server, a second digital wallet, the second digital wallet associated with a second standard rewards value and storing at least one payment card number for a payment card issued by a second issuer, the second issuer having a second issuer server;
receiving at the server, a rewards value from the second issuer server;
applying with the server, the normalizing algorithm to the rewards value from the second issuer server to obtain a second normalized rewards value;
updating with the server, the second standard rewards value by adding the second normalized rewards value to the second standard rewards value; and
adding with the server, the first standard rewards value and the second standard rewards value to obtain a consolidated standard rewards value.

4. The computer-implemented method of claim 3 further comprising the steps of:
sending from the server, the consolidated standard rewards value to the customer device for display;
receiving at the server, instructions from the customer device that a portion or an entirety of the consolidated standard rewards value has been selected; and
providing from the server, the selected portion or the selected entirety of the consolidated standard rewards value to the merchant server for redemption.

5. The computer-implemented method of claim 3 wherein the step of applying the normalizing algorithm comprises scaling the rewards value from the first issuer server or the rewards value from the second issuer server by a predetermined factor, wherein the predetermined factor is correlated to a ratio between the dollar value of the rewards value from the first issuer server and the dollar value of the rewards value from the second issuer server.

6. The computer-implemented method of claim 1 wherein the step of receiving the rewards value from the first issuer server is via an application programming interface (API).

7. The computer-implemented method of claim 3 wherein the step of receiving the rewards value from the second issuer server is via another API.

8. The computer-implemented method of claim 3 wherein the first standard rewards value is stored in the first digital wallet and the second standard rewards value is stored in the second digital wallet.

9. The computer-implemented method of claim 4 wherein the merchant server is associated with a merchant category code such that the selected portion or the selected entirety of the first standard rewards value or the selected portion or the selected entirety of the consolidated standard rewards value can be redeemed.

10. A system for accumulating rewards for redemption comprising:
at least one server configured to:
store a first digital wallet, the first digital wallet associated with a first standard rewards value, and storing at least one payment card number for a payment card issued by a first issuer, the first issuer having a first issuer server;
receive a rewards value from the first issuer server;
apply a normalizing algorithm to the rewards value from the first issuer server to obtain a first normalized rewards value; and
update the first standard rewards value by adding the first normalized rewards value to the first standard rewards value.

11. The system of claim 10 wherein the at least one server is further configured to:
receive instructions that payment is to be made with the first digital wallet;
send the first standard rewards value to a customer device for display;
receive instructions from the customer device that a portion or an entirety of the first standard rewards value has been selected; and
provide the selected portion or the selected entirety of the first standard rewards value to a merchant server for redemption.

12. The system of claim 10 wherein the at least one server is further configured to:
store a second digital wallet, the second digital wallet associated with a second standard rewards value, and storing at least one payment card number for a payment card issued by a second issuer, the second issuer having a second issuer server;
receive a rewards value from the second issuer server;
apply the normalizing algorithm to the rewards value from the second issuer server to obtain a second normalized rewards value;
update the second standard rewards value by adding the second normalized rewards value to the second standard rewards value; and
add the first standard rewards value and the second standard rewards value to obtain a consolidated standard rewards value.

13. The system of claim 12 wherein the at least one server is further configured to:
send the consolidated standard rewards value to the customer device for display;
receive instructions from the customer device that a portion or an entirety of the consolidated standard rewards value has been selected; and
provide the selected portion or the selected entirety of the consolidated standard rewards value to the merchant server for redemption.

14. The system of claim 12 wherein the normalizing algorithm comprises scaling the rewards value from the first issuer server or the rewards value from the second issuer server by a predetermined factor, wherein the predetermined factor is correlated to a ratio between the dollar value of the rewards value from the first issuer server and the dollar value of the rewards value from the second issuer server.

15. The system of claim 10 wherein the at least one server is further configured to receive the rewards value from the first issuer server via an application programming interface (API).

16. The system of claim 12 wherein the at least one server is further configured to receive the rewards value from the second issuer server via another API.

17. The system of claim 12 wherein the first standard rewards value is stored in the first digital wallet and the second standard rewards value is stored in the second digital wallet.

18. The system of claim 13 wherein the merchant server is associated with a merchant category code such that the selected portion or the selected entirety of the first standard rewards value or the selected portion or the selected entirety of the consolidated standard rewards value can be redeemed.

19. A computer program product for accumulating rewards for redemption, the computer program product embodied on a non-transitory computer readable storage medium comprising executable computer readable program code configured to, when executed on at least one processor, cause an apparatus or system to:
store a first digital wallet, the first digital wallet associated with a first standard rewards value, and storing at least one payment card number for a payment card issued by a first issuer, the first issuer having a first issuer server;
receive a rewards value from the first issuer server;
apply a normalizing algorithm to the rewards value from the first issuer server to obtain a first normalized rewards value; and
update the first standard rewards value by adding the first normalized rewards value to the first standard rewards value.

20. The computer program product of claim 19 further comprising computer readable program code configured to, when executed on at least one processor, cause an apparatus or system to:
receive instructions that payment is to be made with the first digital wallet;
send the first standard rewards value to a customer device for display;
receive instructions from the customer device that a portion or an entirety of the first standard rewards value has been selected; and
provide the selected portion or the selected entirety of the first standard rewards value to a merchant server for redemption.

21. The computer program product of claim 19 further comprising computer readable program code configured to, when executed on at least one processor, cause an apparatus or system to:
store a second digital wallet, the second digital wallet associated with a second standard rewards value, and storing at least one payment card number for a payment card issued by a second issuer, the second issuer having a second issuer server;
receive a rewards value from the second issuer server;
apply the normalizing algorithm to the rewards value from the second issuer server to obtain a second normalized rewards value;
update the second standard rewards value by adding the second normalized rewards value to the second standard rewards value; and
add the first standard rewards value and the second standard rewards value to obtain a consolidated standard rewards value.

22. The computer program product of claim 21 further comprising computer readable program code configured to, when executed on at least one processor, cause an apparatus or system to:
send the consolidated standard rewards value to the customer device for display;
receive instructions from the customer device that a portion or an entirety of the consolidated standard rewards value has been selected; and
provide the selected portion or the selected entirety of the consolidated standard rewards value to the merchant server for redemption.

23. The computer program product of claim 21 further comprising computer readable program code configured to, when executed on at least one processor, cause an apparatus or system to:
apply the normalizing algorithm by scaling the rewards value from the first issuer server or the rewards value from the second issuer server by a predetermined factor, wherein the predetermined factor is correlated to a ratio between the dollar value of the rewards value from the first issuer server and the dollar value of the rewards value from the second issuer server.
